(19) United States
(12) Patent Application Publication
(10) Pub. No.: US 2006/0159375 A1
(43) Pub. Date: Jul. 20, 2006

(54) Inverted ball joint

(76) Inventors: Swaminathan Krishnan, Sterling Heights, MI (US); Tomasz Buchner, Sterling Heights, MI (US); Charles Buthala, Southfield, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/037,312

(22) Filed: Jan. 18, 2005

(51) Int. Cl. F16C 25/04; F16C 23/04; F16C 29/06; F16C 23/08

(52) U.S. Cl. 384/192

(57) ABSTRACT

An inverted ball joint is adapted to mount between a first vehicle suspension member and a second vehicle suspension member. The inverted ball joint may include a ball stud having a shank portion extending from a ball portion, with the ball portion including a first surface that has a generally convex semi-spherical shape adjacent to the shank portion and an opposed second surface facing away from the shank portion that has a generally concave semi-spherical shape. A first bearing includes a first surface that has a generally convex semi-spherical shape that matches the curvature of and is in sliding engagement with the second surface of the ball portion, and an opposed second surface that has a generally concave shape. A second bearing includes a first surface having a generally concave semi-spherical shape matching the curvature of and in sliding engagement with the first surface of the ball portion, and an opposed second surface. A socket shell includes a first bearing support portion having a generally convex shape and being in supporting engagement with the second surface of the first bearing, and a second bearing support portion in supporting engagement with the second surface of the second bearing.

### BACKGROUND OF INVENTION

The present invention relates to ball joints, and more particularly to ball joints employed in vehicle suspension systems.

A conventional ball joint (also called ball and socket assembly) employed in vehicle applications couples a first vehicle member to a second vehicle member and enables relative movement between the two members. A typical vehicle application is in the front suspension of a vehicle. These conventional ball joints include a socket and a ball stud. The socket includes a bearing, which defines a generally spherical hollow cavity, and a shell, which surrounds and supports the bearing and connects to one of the vehicle members. The ball stud has a generally spherical ball portion, which is received in the cavity and retained by the bearing for pivotal movement relative thereto, and a shank portion, which extends from the socket and connects to the other of the vehicle members. Thus, the two members are secured together, yet limited pivoting between them is allowed.

These conventional ball joints, however, may be longer than is desired for the packaging space available in certain vehicle applications. Moreover, many of the conventional ball joints employed in vehicle suspensions include a stud that has an undercut in the shank adjacent to the ball in order to obtain sufficient articulation angle. With this undercut, an additional element, such as a support collar, may be needed to keep the grease seal from slipping into the undercut. Thus, it is desirable to have a ball joint that provides the support and relative movement required in vehicle suspension systems while overcoming some of the drawbacks of conventional ball joints.

### SUMMARY OF INVENTION

An embodiment of the present invention contemplates an inverted ball joint. The inverted ball joint may include a ball stud having a shank portion extending from a ball portion, with the ball portion including a first surface that has a generally convex semi-spherical shape adjacent to the shank portion and an opposed second surface facing away from the shank portion that has a generally concave semi-spherical shape; and a first bearing including a first surface that has a generally convex semi-spherical shape matching the curvature of and in sliding engagement with the second surface of the ball portion, and an opposed second surface that has a generally concave shape. This inverted ball joint may also include a second bearing including a first surface having a generally concave semi-spherical shape matching the curvature of and in sliding engagement with the first surface of the ball portion, and an opposed second surface; and a socket shell including a first bearing support portion having a generally convex shape and being in supporting engagement with the second surface of the first bearing, and a second bearing support portion in supporting engagement with the second surface of the second bearing.

An embodiment of the present invention also contemplates a vehicle suspension. The vehicle suspension includes a first suspension member, and a second suspension member. The vehicle suspension also includes an inverted ball joint including ball stud having a shank portion mounted to the second suspension member and extending from a ball portion, with the ball portion including a first surface that has a generally convex semi-spherical shape adjacent to the shank portion and an opposed second surface facing away from the shank portion that has a generally concave semi-spherical shape; a first bearing including a first surface that has a generally convex semi-spherical shape matching the curvature of and in sliding engagement with the second surface of the ball portion, and an opposed second surface that has a generally concave shape; a second bearing including a first surface having a generally concave semi-spherical shape matching the curvature of and in sliding engagement with the first surface of the ball portion, and an opposed second surface; and a socket shell including a first bearing support portion having a generally convex shape and being in supporting engagement with the second surface of the first bearing, a second bearing support portion in supporting engagement with the second surface of the second bearing, and an outer surface retained by the first suspension member.

An advantage of the present invention is that the inverted ball joint, and especially the socket shell, is shorter than with a conventional ball joint. Thus, the inverted ball joint can be used where packaging space would not allow for a conventional ball joint. Moreover, the shorter inverted ball joint uses less material than the conventional ball joint, thus reducing the material expense.

Another advantage of the present invention is that the stud does not need an undercut adjacent to the ball portion in order to achieve the desired articulation angle, thus eliminating the concern that the seal will slip into such an undercut. This makes the support collar employed with a conventional ball joint optional.

A further advantage of the present invention is that, with the inverted ball joint having a relatively shallow socket shell, the socket shell may be formed by a stamping operation. Forming the socket shell by a stamping operation is generally less costly than forming methods employed with the conventional ball joints.

### BRIEF DESCRIPTION OF DRAWINGS

FIG. 1 is a cross section view of an inverted ball joint assembled to vehicle members in accordance with an embodiment of the present invention.

FIG. 2 is an exploded perspective view of the inverted ball joint of FIG. 1.

FIG. 3 is an elevation view of a stud of the inverted ball joint of FIG. 1.

FIG. 4 is a plan view of a first bearing of the inverted ball joint of FIG. 1.

FIG. 5 is a plan view of a second bearing of the inverted ball joint of FIG. 1.

FIG. 6 is a cross section view of an inverted ball joint in accordance with a second embodiment of the present invention.

### DETAILED DESCRIPTION

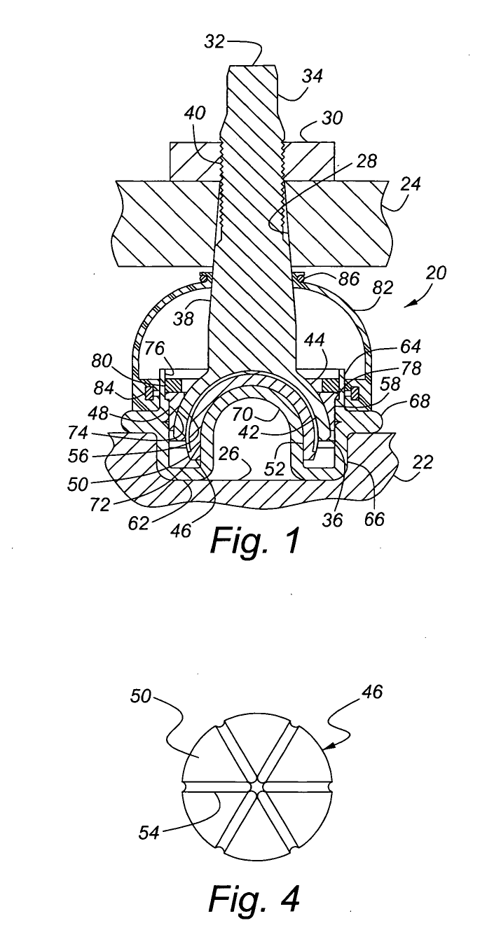

Referring to FIG. 1, an inverted ball joint 20 (also called a ball and socket assembly) is shown securing a first suspension member 22 to a second suspension member 24. The first and second suspension members 22, 24 may be, for example, a steering knuckle, a steering yoke, and/or a control arm. The first suspension member 22 may include a generally cylindrical opening 26 within which a portion of the ball joint 20 is secured. The second suspension member 24 may include a hole 28 through which a portion of the inverted ball joint 20 passes. A nut 30, or other securing means, may thread onto a portion of the inverted ball joint 20 to secure the second suspension member 24 to the inverted ball joint 20.

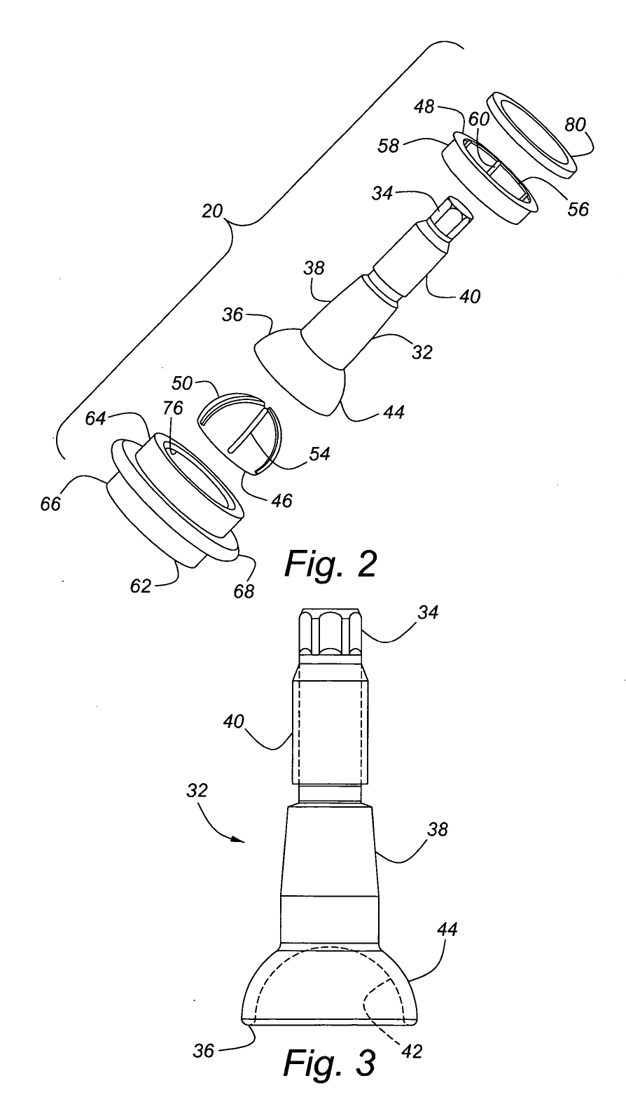

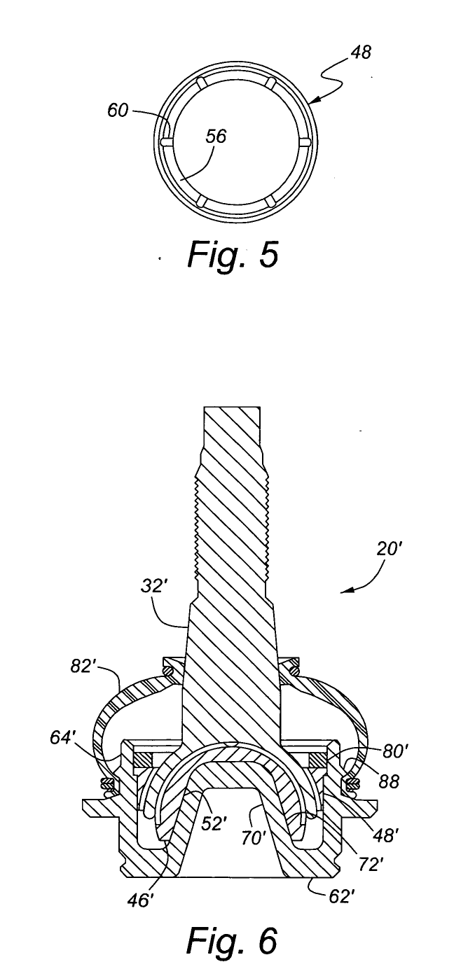

The first embodiment will now be discussed with reference to FIGS. 1-5. The inverted ball joint 20 includes a stud 32, which is preferably made of steel, although other suitable materials may be employed if so desired. The stud 32 has a shank portion 34 extending from a generally bowl shaped ball portion 36. The shank portion 34 has a first section 38, adjacent to the ball portion 36, that mates with the second suspension member 24, and a second section 40, extending from the first section 38, that includes threads for engaging with the nut 30. The ball portion 36 extends from the shank portion 34 to define a concave, semi-spherically shaped bearing surface 42 on a side facing away from the shank portion 34, and a convex, semi-spherical surface 44 on the side adjacent to the shank portion 34.

The inverted ball joint 20 also includes a first bearing 46 and a second bearing 48. The first and second bearings 46, 48 are preferably made of a plastic, such as, for example, nylon or Delrin™ acetal resin made by DuPont of Wilmington, Del. The first bearing 46 includes a first surface 50 that has a generally semi-spherical convex shape and an opposed second surface 52 that has a generally semi-spherical concave shape. The first surface 50 has about the same radius of curvature as the concave semi-spherical surface 42 of the ball portion 36 (matching curvature) so that it is in mating and sliding contact with the concave semi-spherical surface 42. Also, the first surface 50 preferably extends about a greater arc of the spherical shape than the concave semi-spherical surface 42 so that, when the stud 32 pivots relative to the first bearing 46, the concave semi-spherical surface 42 will retain its full bearing surface contact with the first surface 50. Optionally, the first bearing surface 50 may include grease channels 54 for improving the lubrication of the joint. Of course, when speaking of mating engagement or sliding or bearing contact between the surfaces herein, this contemplates that a layer of lubricant may be located between and coating the components, as is known in the art.

The second bearing 48 is ring shaped, with a first surface 56 that has a generally semi-spherical concave shape and a second outer surface 58 that has a generally cylindrical shape. The first surface 56 has about the same radius of curvature as the convex semi-spherical surface 44 of the ball portion 36 so that it is in mating and sliding contact with the convex semi-spherical surface 44. Optionally, the second bearing 48 may include grease channels 60, if so desired.

A socket shell 62 forms a part of the inverted ball joint 20. The socket shell 62 is preferably made of steel, although other suitable materials may be employed instead, if so desired. Also, the socket shell 62 is preferably formed by a stamping operation in order to minimize costs, but other forming methods may be used instead. The socket shell 62 has an outer surface 64 with a first portion 66 that is inserted into and engages with the opening 26 in the first suspension member 22. A flange 68 may extend radially outward from the outer surface 64. The socket shell 62 includes a bearing support portion 70 that has a convex semi-spherical surface 72 in mating contact with the second surface 52 of the first bearing 46. This bearing support portion 70 provides support for the first bearing 46 and helps orient and maintain the first bearing 46 against the concave surface 42 of the ball portion 36. The socket shell 62 also has an inner surface 76 that includes a first portion 74 and a lip 78. The first portion 74 mates with and provides radial support for the second surface 58 of the second bearing 48, while the lip 78 engages the second bearing 48 to locate it axially.

A ring-shaped retainer 80 is press fit into the socket shell 62 and secured against its inner surface 76 in order to hold the second bearing 48 and, consequently, the other components in place relative to one another and relative to the socket shell 62. The retainer 80 is preferably made of steel, although other suitable materials may be used instead, if so desired. Also, as an alternative, or, preferably, in addition to the retainer 80, the material around the open end of the socket shell 62 may be rolled over (not shown) the retainer 80 and/or second bearing 48 to secure all of the components of the inverted ball joint 20 in place.

The ball joint also preferably includes a grease seal 82. The seal 82 may extend between the outer surface 64 of the socket shell 62 and the first section 38 of the shank portion 34. An annular washer 84—or alternatively a ring spring—may engage the seal 82 in order to secure the seal 82 against the outer surface 64 of the socket shell 62. A ring spring 86—or alternatively an annular washer—may engage the seal 82 in order to compress the seal 82 against the surface of the first section 38 of the shank portion 34. The purpose of the seal 82 is to prevent lubricant (such as grease) from leaking from the inverted ball joint 20 and also to prevent contaminants from entering the ball joint 20.

The inverted ball joint 20—even though there is no full spherical ball, as is the case with conventional ball joints—will support the first suspension member 22 relative to the second suspension member 24 just like the conventional ball joint. Moreover, the bowl shaped ball portion 36 of the stud 32, being sandwiched between and in bearing contact with the first and second bearings 46, 48, is rotatable and pivotable relative to these bearings, allowing for movement like a conventional ball joint. And yet, with only a semi-spherical shape, the inverted ball joint 20 accomplishes these functions with a shorter packaging height and, consequently, with less material.

FIG. 6 illustrates a second embodiment of the present invention. The inverted ball joint 20′ still includes a stud 32′ in mating engagement with a first bearing 46′ and a second bearing 48′, with a retainer 80′ securing them in the socket shell 62′. In this embodiment, though, the shape of the second surface 52′ of the first bearing 46′ and the shape of the surface 72′ of the bearing support portion 70′ are different. The mating surfaces 52′, 72′ between the socket shell 62′ and the first bearing 46′ are generally conical shaped surfaces, rather than spherical, as is the case in the fist embodiment. Yet, the bearing support portion 70′ still provides the needed support for the first bearing 46′. As another alternative for these two mating surfaces, the shapes do not necessarily have to be surfaces of revolution (such as a cone or sphere) since they do not need to pivot or move relative to each other during operation of the inverted ball joint 20′. Other shapes can be employed, as long as the convex bearing support portion still provides adequate support for the concave surface of the first bearing. But the assembly may be easier with mating surfaces of revolution since they wouldn't require any particular rotational orientation of the mating surfaces during assembly. In addition, in this embodiment, the outer surface 64′ of the socket shell 62′ is modified somewhat in order to provide a more positive retention feature 88 for the grease seal 82′. The use and operation of the inverted ball joint 20′ is the same as with the first embodiment.

While certain embodiments of the present invention have been described in detail, those familiar with the art to which this invention relates will recognize various alternative designs and embodiments for practicing the invention as defined by the following claims.

What is claimed is:

1. An inverted ball joint comprising;
a ball stud having a shank portion extending from a ball portion, with the ball portion including a first surface that has a generally convex semi-spherical shape adjacent to the shank portion and an opposed second surface facing away from the shank portion that has a generally concave semi-spherical shape;
a first bearing including a first surface that has a generally convex semi-spherical shape matching the curvature of and in sliding engagement with the second surface of the ball portion, and an opposed second surface that has a generally concave shape;
a second bearing including a first surface having a generally concave semi-spherical shape matching the curvature of and in sliding engagement with the first surface of the ball portion, and an opposed second surface; and
a socket shell including a first bearing support portion having a generally convex shape and being in supporting engagement with the second surface of the first bearing, and a second bearing support portion in supporting engagement with the second surface of the second bearing.

2. The inverted ball joint of claim 1 further including a flexible seal having a first end sealingly engaging the socket shell and a second end sealingly engaging the shank portion.

3. The inverted ball joint of claim 2 further including a retainer mounted within the socket shell and abutting the second bearing to thereby retain the second bearing in the socket shell.

4. The inverted ball joint of claim 1 further including a retainer mounted within the socket shell and abutting the second bearing to thereby retain the second bearing in the socket shell.

5. The inverted ball joint of claim 1 wherein the generally concave shape of the second surface of the first bearing is semi-spherical, and the first bearing support portion has a convex semi-spherical surface in supporting engagement with the second surface of the first bearing.

6. The inverted ball joint of claim 1 wherein the generally concave shape of the second surface of the first bearing is generally conical, and the first bearing support portion has a convex conical surface in supporting engagement with the second surface of the first bearing.

7. The inverted ball joint of claim 1 wherein the first surface of the first bearing includes grease channels extending therealong.

8. The inverted ball joint of claim 1 wherein the first surface of the second bearing includes grease channels extending therealong.

9. The inverted ball joint of claim 1 wherein the second surface of the second bearing has a generally cylindrical shape.

10. The inverted ball joint of claim 1 wherein the socket shell includes a lip that axially engages the second bearing.

11. The inverted ball joint of claim 1 wherein the socket shell is a metal stamping.

12. A vehicle suspension comprising:
a first suspension member;
a second suspension member; and
an inverted ball joint including ball stud having a shank portion mounted to the second suspension member and extending from a ball portion, with the ball portion including a first surface that has a generally convex semi-spherical shape adjacent to the shank portion and an opposed second surface facing away from the shank portion that has a generally concave semi-spherical shape; a first bearing including a first surface that has a generally convex semi-spherical shape matching the curvature of and in sliding engagement with the second surface of the ball portion, and an opposed second surface that has a generally concave shape; a second bearing including a first surface having a generally concave semi-spherical shape matching the curvature of and in sliding engagement with the first surface of the ball portion, and an opposed second surface; and a socket shell including a first bearing support portion having a generally convex shape and being in supporting engagement with the second surface of the first bearing, a second bearing support portion in supporting engagement with the second surface of the second bearing, and an outer surface retained by the first suspension member.

13. The vehicle suspension of claim 12 further including a flexible seal having a first end sealingly engaging the socket shell and a second end sealingly engaging the shank portion.

14. The vehicle suspension of claim 1 further including a retainer mounted within the socket shell and abutting the second bearing to thereby retain the second bearing in the socket shell.

15. The vehicle suspension of claim 12 wherein the generally concave shape of the second surface of the first bearing is semi-spherical, and the first bearing support portion has a convex semi-spherical surface in supporting engagement with the second surface of the first bearing.

16. The vehicle suspension of claim 12 wherein the generally concave shape of the second surface of the first bearing is generally conical, and the first bearing support portion has a convex conical surface in supporting engagement with the second surface of the first bearing.

17. The vehicle suspension of claim 12 wherein the second surface of the second bearing has a generally cylindrical shape.

18. The vehicle suspension of claim 12 wherein the socket shell includes a lip that axially engages the second bearing.

19. The vehicle suspension of claim 12 wherein the socket shell includes a radially outwardly extending flange adjacent to the first suspension member.

20. An inverted ball joint comprising;
a ball stud having a shank portion extending from a ball portion, with the ball portion including a first surface that has a generally convex semi-spherical shape adjacent to the shank portion and an opposed second surface facing away from the shank portion that has a generally concave semi-spherical shape;
a first bearing including a first surface that has a generally convex semi-spherical shape matching the curvature of and in sliding engagement with the second surface of the ball portion, and an opposed second surface that has a generally concave semi-spherical shape;
a second bearing including a first surface having a generally concave semi-spherical shape matching the curvature of and in sliding engagement with the first surface of the ball portion, and an opposed second surface;
a socket shell including a first bearing support portion having a generally convex semi-spherical surface in supporting engagement with the second surface of the first bearing, and a second bearing support portion in supporting engagement with the second surface of the second bearing; and
a retainer mounted within the socket shell and abutting the second bearing to thereby retain the second bearing in the socket shell.
